(19) United States
(12) Patent Application Publication
(10) Pub. No.: US 2009/0163401 A1
(43) Pub. Date: Jun. 25, 2009

(54) Liquid Detergent Composition

(75) Inventors: Philip Gorlin, Flemington, NJ (US); Neil Sheth, Cherry Hill, NJ (US); Kevin Kinscherf, Middletown, NJ (US); Melissa Fleckenstein, Clark, NJ (US)

Correspondence Address: COLGATE-PALMOLIVE COMPANY, 909 RIVER ROAD, PISCATAWAY, NJ, 08855, US

(73) Assignee: COLGATE-PALMOLIVE COMPANY, NEW YORK, NY (US)

(21) Appl. No.: 12/396,007

(22) Filed: Mar. 2, 2009

Related U.S. Application Data
(63) Continuation of application No. 11/627,048, filed on Jan. 25, 2007.
(60) Provisional application No. 60/845,055, filed on Sep. 15, 2006.

(51) Int. Cl. C11D 17/08

(52) U.S. Cl. 510/418

(57) ABSTRACT

A liquid detergent composition comprising surfactants, at least one suspending agent, beads having a particle size of 100 to 2500 microns suspended in the composition, and water wherein the surfactants comprise: a) at least one of a salt of a C₁₀-C₂₀ paraffin sulfonate surfactant, b) at least one of a salt of an ethoxylated C₁₀-C₁₆ pareth sulfate surfactant having 1 to 30 moles of ethylene oxide; and c) at least one amine oxide surfactant.

### CROSS REFERENCE TO RELATED APPLICATION

This application is a continuation application of U.S. patent application Ser. No. 11/627,048, filed Jan. 25, 2007, which claims priority to U.S. Provisional Application Ser. No. 60/845,055, filed on 15 Sep. 2006, which is incorporated herein by reference.

### BACKGROUND OF THE INVENTION

Structured liquids are known in the art for suspending beads or particles in cleaning liquid compositions. The means of providing structure to the liquid includes using particular surfactants that thicken the liquid, or by the addition of thickening agents such as polymers and gums which thicken the liquid so as to be able to suspend particles or beads therein for long periods of time.

The by-product of thickening a liquid to provide structure for suspended beads causes a significant increase in liquid viscosity and a corresponding decrease in liquid pourability, a property which consumers generally do not associate with certain products, such as a liquid detergent product.

### SUMMARY OF THE INVENTION

A liquid detergent composition comprising surfactants, at least one suspending agent, beads having a particle size of 100 to 2500 microns suspended in the composition, and water wherein the surfactants comprise:
a) at least one of a salt of a C₁₀-C₂₀ paraffin sulfonate surfactant,
b) at least one of a salt of an ethoxylated C₁₀-C₁₆ pareth sulfate surfactant having 1 to 30 moles of ethylene oxide; and
c) at least one amine oxide surfactant.

### DETAILED DESCRIPTION OF THE INVENTION

As used throughout, ranges are used as a shorthand for describing each and every value that is within the range. Any value within the range can be selected as the terminus of the range.

The liquid detergent composition contains surfactants that are present in an amount that is at least 15% by weight of the liquid detergent composition based on the active amount of the surfactant. In other embodiments, the amount of surfactant is at least 20%, at least 24%, at least 30%, at least 35%, or at least 40% by weight. In another embodiment, the amount of surfactant ranges from 15% to 45% by weight.

As used throughout, the counter ion in the salts of paraffin sulfonate surfactants and pareth sulfate surfactants include, but are not limited to sodium, magnesium, and ammonium.

The paraffin sulfonates (also known as secondary alkane sulfonates) may be monosulfonates or di-sulfonates and usually are mixtures thereof, obtained by sulfonating paraffins of 10 to 20 carbon atoms. Commonly used paraffin sulfonates are those of C12-18 carbon atoms chains, and more commonly they are of C14-17 chains. Paraffin sulfonates that have the sulfonate group(s) distributed along the paraffin chain are described in U.S. Pat. Nos. 2,503,280; 2,507,088; 3,260,744; and 3,372,188; and also in German Patent 735,096. Such compounds may be made to specifications and desirably the content of paraffin sulfonates outside the C14-17 range will be minor and will be minimized, as will be any contents of di- or poly-sulfonates. Examples of paraffin sulfonates include, but are not limited to HOSTAPUR™ SAS30, SAS 60, and SAS 93 secondary alkane sulfonates from Clariant, BIO-TERGE™ surfactants from Stepan, and CAS No. 68037-49-0.

The amount of paraffin sulfonate can be any desired amount. In one embodiment, the amount is 1 to 30% by weight of the composition. In other embodiments, the amount is 15-25% by weight, or 17.5-18% by weight.

The pareth sulfate surfactant is a salt of an ethoxylated C₁₀-C₁₆ pareth sulfate surfactant having 1 to 30 moles of ethylene oxide. In some embodiments, the amount of ethylene oxide is 1 to 6 moles, and in other embodiments it is 2 to 3 moles, and in another embodiment it is 2 moles. In one embodiment, the pareth sulfate is a C₁₂-C₁₃ pareth sulfate with 2 moles of ethylene oxide. An example of a pareth sulfate surfactant is STEOL™ 23-2S/70 from Stepan, or (CAS 68585-34-2).

The amount of pareth sulfate can be any desired amount. In one embodiment, the amount is 1-20% by weight of the composition. In other embodiments, the amount is 1-10% by weight, or 4 to 6% b) weight, or 4.7 to 5.3% by weight.

Amine oxide semi-polar nonionic surfactants can comprise compounds and mixtures of compounds having the formula:

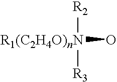

wherein R₁ is an alkyl, 2-hydroxyalkyl, 3-hydroxyalkyl, or 3-alkoxy-2-hydroxypropyl radical in which the alkyl and alkoxy, respectively, contain from 8 to 18 carbon atoms, R₂ and R₃ are each methyl, ethyl, propyl, isopropyl, 2-hydroxyethyl, 2-hydroxypropyl, or 3-hydroxypropyl, and n is from 0 to 10. Particularly preferred are amine oxides of the formula:

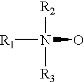

wherein R₁ is a C₁₂₋₁₆ alkylamidopropyl group and R₂ and R₃ are methyl or ethyl. The above ethylene oxide condensates, amides, and amine oxides are more fully described in U.S. Pat. No. 4,316,824.

In one embodiment, the at least one amine oxide surfactant comprises a mixture of lauramidopropyldimethylamine oxide and myristamidopropylamine oxide.

The amount of amine oxide surfactants can be any amount. In one embodiment, the amount is 1 to 10% by weight. In other embodiments, the amount is 2 to 6% by weight, or 2-3% by weight.

Additional surfactants, such as anionic surfactants, nonionic surfactants, amphoteric surfactants, and zwitterionic surfactants can be included in the liquid detergent composition.

Suspending agents are any material that increases the ability of the liquid detergent composition to suspend material. Examples of suspending agents include, but are not limited to gum suspending agents and synthetic polymer suspending agents. Examples of gum suspending agents include, but are not limited to, gellan gum, pectine, alginate, arabinogalactan, carageenan, xanthum gum, guar gum, rhamsan gum, furcellaran gum, and combinations thereof. A preferred suspending agent is gellan gum, and it can be obtained from CP Kelco under the tradename KELCOGEL™. In one embodiment, the gellan gum is KELCOGEL™ AFT.

The synthetic polymer suspending agent is preferably a polyacrylate. One acrylate aqueous solution used to allow a stable suspension of the solid particles is manufactured by Noveon as CARBOPOL™ Aqua 30. The CARBOPOL™ resins, also known as CARBOMER™, are hydrophilic high molecular weight, crosslinked acrylic acid polymers having an average equivalent weight of 76, and the general structure illustrated by the following formula has a molecular w eight of about 1,250,000; CARBOPOL™ 940 a molecular weight of approximately 4,000,000 and CARBOPOL™ 934 a molecular weight of approximately 3,000,000. The CARBOPOL™ resins are crosslinked with polyalkenyl polyether, e.g. about 1% of a polyalkyl ether of sucrose having an average of about 5,8 alkyl groups for each molecule of sucrose.

The suspending agent can be included in the composition in any amount to give a desired amount of suspension. In one embodiment, the amount of suspending agent is 0.01-10% by weight of the composition. In another embodiment, the amount is 0.1-0.2% by weight.

The beads can be made from a variety of materials as long as their composition and size permit the suspension of the beads in the liquid detergent composition. Examples of beads include, but are not limited to, gelatin, celluloses, agar, gum arabic, alginates, waxes, polyethylenes, polyvinyl alcohol, poly(meth)acrylates, polystyrenes, polyurethanes, polyamides, polyepoxides, vinyl acetates, and polyvinyl pyrrolidones. Preferably, the beads are made from at least one of agar, alginate, gum arabic, and/or gelatin. These types of beads can be obtained from Lipo Technologies, Inc. under the tradename LIPOSPHERES or International Specialty Products under the tradename CAPTIVATES. These types of beads are porous and allow the bulk liquid that they are placed in to diffuse into the bead. This helps the beads become density matched to the composition to aid in suspension of the bead. Alternatively, materials can be encapsulated into beads to change their density to match the density of the bulk liquid.

The amount of beads in the liquid detergent composition can be any desired amount. In one embodiment, the amount of beads is 0.01% to 10% by weight of the composition, or 0.01 to 2% by weight.

Beads can be of any size that is viewable by a person. By viewable it is meant that the beads can be seen by a non-color blind person with an unaided eye at 20/20 or corrected to 20/20 with glasses or contact lenses at a distance of 30 cm from the composition under incandescent light, florescent light, or sunlight. In other embodiments, at least 50%, at least 60%, at least 70%, at least 80%, at least 90%, at least 95%, or at least 99% of the beads are viewable by a person. In one embodiment, the particle size is 100 to 2500 microns in a longest dimension of the bead. In another embodiment, the particle size is 250 to 2250 microns. In another embodiment, the particle size is 500 to 1500 microns. In another embodiment, the particle size is 700 to 1000 microns. In another embodiment, a combination of more than one particle size can be used. In another embodiment, there is a combination of five particle sizes.

The liquid detergent composition can keep the suspended materials suspended for at least 2 weeks at room temperature (23-25° C.). By suspended it is meant that at least 90%, or at least 95%, or at least 97%, or at least 99% of the suspended material remains suspended in the composition without settling out to the bottom of the liquid. This is measured by counting the number of particles that remain suspended in the liquid after the elapse of time as compared to the number of particles in the composition initially. In other embodiments, the suspended material can be suspended for at least two months, at least six months, or at least one year at room temperature (23-25° C.). In other embodiments, the composition can keep the suspended materials suspended for at least 18 weeks at 40.5° C. (105° F.). In another embodiment, the composition can keep the suspended material suspended for at least 2 weeks at −10° C. In another embodiment, the composition can keep the suspended material suspended for at least 3 weeks at 4.5° C. While factors such as the amount of surfactant, the size of the suspended materials, and the amount of suspending agent can affect stability, amounts for each of these factors can be selected so that the above stability tests are met.

The present liquid detergent compositions are made by simple mixing methods from readily available components which, on storage, do not adversely affect the entire composition. Mixing can be done by any mixer that forms the composition. Examples of mixers include, but are not limited to, static mixers and in-line mixers. Solubilizing agents such as a C₁-C₃ alkyl substituted benzene sulfonate such as sodium cumene or sodium xylene sulfonate and mixtures thereof are used at a concentration of 0.5 weight % to 10 weight % to assist in solubilizing the surfactants.

The viscosity of the composition can be adjusted to give any desired viscosity. In one embodiment, the viscosity is less than 5,000 mPas. In another embodiment, the viscosity is less than 1,000 mPas. In another embodiment, the viscosity is 500-1000 mPas, or 550-950 mPas. Viscosity is measured using a Brookfield RVT Viscometer using a number 21 spindle rotating at 20 rpm at 25° C. The liquid detergent compositions of the instant invention are pourable and have an apparent yield value of at least 5 Pa.

The pH of the composition can be formulated to be any pH. In one embodiment, the pH is 3-10. In another embodiment, the pH is 6-8 or 7-8.

In addition, the liquid detergent composition may also employ normal and conventional adjuvants. Thus, there may be used various coloring agents and perfumes; ultraviolet light absorbers such as the Uvinuls, which are products of GAF Corporation; sequestering agents such as ethylene diamine tetraacetates; magnesium sulfate heptahydrate; pH modifiers; etc. The proportion of such adjuvant materials, in total will normally not exceed 15% by weight of the detergent composition, and the percentages of most of such individual components will be a maximum of 5% by weight and preferably less than 2% by weight. Sodium bisulfite can be used as a color stabilizer at a concentration of 0.01 to 0.2 weight %. Other additives can be found in the patents and patent application publications referenced above.

The liquid detergent composition can further include a chelant to assist in cleaning. In one embodiment, the chelant is an iminodisuccinate. In one embodiment, the iminodisuccinate is a sodium iminodisuccinate (CAS No. 144538-83-0), which is available from Bayer under the trade name BAYPURE™. This iminodisuccinate is described in U.S. Pat. No. 5,977,053, which is incorporated herein by reference only for the description of the iminodisuccinate. The chelant can be present in any desired amount. In one embodiment, the amount is 0.01 to 1% by weight, and in another embodiment, the amount is 0.1 to 0.2% by weight.

The liquid detergent composition may also contain solvents or salts to modify the cleaning, stability and rheological properties of the composition.

Solvents can include any water soluble solvents. Water soluble solvents include, but are not limited to, C₂₋₄ mono, dihydroxy, or polyhydroxy alkanol and/or an ether or diether, such as ethanol, isopropanol, diethylene glycol monobutyl ether, dipropylene glycol methyl ether, dipropyleneglycol monobutyl ether, propylene glycol n-butyl ether, propylene glycol, and hexylene glycol, and alkali metal cumene, alkali metal toluene, or alkali metal xylene sulfonates such as sodium cumene sulfonate and sodium xylene sulfonate. Preferred solvents are ethanol and diethylene glycol monobutyl ether, both of which are miscible with water. Urea can be optionally used at a concentration of 0.1% to 7 weight %.

Salts can include any desirable salt. Examples of salts include, but are not limited to, sodium chloride and magnesium sulfate.

Additional optional ingredients may be included to provide added effect or to make the product more attractive. Such ingredients include, but are not limited to, abrasive agents, disinfectants, radical scavengers, bleach, chelating agents, antibacterial agents/preservatives, optical brighteners, hydrotropes, citric acid, or combinations thereof.

In some embodiments, preservatives can be used in the instant compositions at a concentration of 0 weight % to 3 weight %, more preferably 0.01 weight % to 2.5 weight %. Examples of preservatives include, but are not limited to, benzalkonium chloride; benzethonium chloride, 5-bromo-5-nitro-1,3dioxane; 2-bromo-2-nitropropane-1,3-diol; alkyl trimethyl ammonium bromide; N-(hydroxymethyl)-N-(1,3-dihydroxy methyl-2,5-dioxo-4-imidaxolidinyl-N′-(hydroxy methyl)urea; 1-3-dimethyol-5,5-dimethyl hydantoin; formaldehyde; iodopropynl butyl carbamate, butyl paraben; ethyl paraben; methyl paraben; propyl paraben, mixture of methyl isothiazolinone/methyl-chloroisothiazoline in a 1:3 wt. ratio; mixture of phenoxythanol/butyl paraben/methyl paraben/propylparaben; 2-phenoxyethanol; tris-hydroxyethyl-hexahydrotriaz-ine; methylisothiazolinone; 5-chloro-2-methyl-4-isothiazolin-3-one; 1,2-dibromo-2,4-dicyanobutane; 1-(3-chloroalkyl)-3,5,7-triaza-azoniaadam-antane chloride; and sodium benzoate.

In one embodiment, the surfactants comprise 14-20% by weight of sodium C₁₄-C₁₇ paraffin sulfonate, 3-6% by weight of sodium C₁₂-C₁₃ pareth sulfate(2EO), 1-3% by weight of lauramidopropyldimethylamine oxide, and 0.1-1% by weight myristamidopropylamine oxide, and the suspending agent is gellan gum, which is present at 0.1-0.2% by weight, all on an actives basis.

The liquid detergent compositions of the present invention can be formulated into dishwashing detergents, laundry detergents, or hand soaps.

The following example illustrates liquid cleaning compositions of the described invention, which includes optional materials. Unless otherwise specified, all percentages are by weight. The exemplified compositions are illustrative only and do no limit the scope of the invention. Unless otherwise specified, the proportions in the examples and elsewhere in the specification are by active weight. The active weight of a material is the weight of the material itself excluding water or other materials that may be present in the supplied form of the material.

The following materials can be mixed together to form a liquid detergent composition.

TABLE 1

| Material | Wt. % |
|---|---|
| Sodium C14-C17 paraffin sulfonate | 17.5-18 |
| Sodium C12-C13 pareth sulfate (2EO) | 4.7-5.3 |
| Lauramidopropyldimethylamine oxide | 1.5-2 |
| Myristamidopropylamine oxide | 0.4-0.8 |
| Gellan gum (KELCOGEL ™ AFT) | 0.12-0.13 |
| Sodium Chloride | 1.8-2.2 |
| LIPOSPHERE ™ LTI-0507 beads (750 μm, orange) | 0.5-0.6 |
| Fragrance | 0.01-1 |
| Colorant (LIQUITINT ™ bright yellow) | 0.01-0.03 |
| Sodium Bisulfite | 0.1-0.3 |
| Citric acid | 0-0.015 |
| Biocide | QS |
| water | QS |
| Total | 100% |
| pH | 7-8 |
| Brookfield viscosity | approx. 750 mPas |

The following materials can be mixed together to form a liquid detergent composition.

TABLE 2

| Material | Wt. % |
|---|---|
| Sodium C14-C17 paraffin sulfonate | 15.7-16.2 |
| Sodium C12-C13 pareth sulfate (2EO) | 3.5-4.1 |
| Lauramidopropyldimethylamine oxide | 1.7-2.3 |
| Myristamidopropylamine oxide | 0.5-0.9 |
| Gellan gum (KELCOGEL ™ AFT) | 0.12-0.13 |
| Sodium Chloride | 1.8-2.2 |
| LIPOSPHERE ™ LTI-0507 beads (750 μm, orange) | 0.5-0.6 |
| Fragrance | 0.01-1 |
| Colorant (LIQUITINT ™ bright yellow) | 0.01-0.03 |
| Sodium Bisulfite | 0.1-0.3 |
| Citric acid | 0-0.015 |
| Biocide | QS |
| water | QS |
| Total | 100% |
| pH | 7-8 |
| Brookfield viscosity | Approx. 750 mPas |

What is claimed is:

1. A liquid detergent composition comprising surfactants, a suspending agent, beads having a particle size of 100 to 2500 microns suspended in the composition, and water, wherein the surfactants consist essentially of:
a) at least one of a salt of a C₁₀-C₂₀ paraffin sulfonate surfactant,
b) at least one of a salt of an ethoxylated C₁₀-C₁₆ pareth sulfate surfactant having 1 to 30 moles of ethylene oxide, and
c) at least one amine oxide surfactant; and
wherein the suspending agent consists essentially of a gellan gum.

2. The liquid detergent composition of claim 1 further comprising a chelant.

3. The liquid detergent composition of claim 1 further comprising a sodium iminodisuccinate.

4. The liquid detergent composition of claim 1, wherein the at least one amine oxide surfactant is a mixture of lauramidopropyldimethylamine oxide and myristamidopropylamine oxide.

5. The liquid detergent composition of claim 1, wherein the surfactants are present at least 20% by weight in the composition on an actives basis.

6. The liquid detergent composition of claim 1, wherein the surfactants are present at least 20% by weight in the composition on an actives basis.

7. The liquid detergent composition of claim 1, wherein the surfactants consist essentially of a mixture of a sodium C₁₄-C₁₇ paraffin sulfonate, a sodium C₁₂-C₁₃ pareth sulfate (2EO), lauramidopropyldimethylamine oxide, and myristamidopropylamine oxide.

8. The liquid detergent composition of claim 7, wherein the surfactants are present at least 24% by weight in the composition on an actives basis.

9. The liquid detergent composition of claim 1, wherein the at least one of a salt of a C₁₀-C₂₀ paraffin sulfonate surfactant is present at 1 to 30% by weight of the composition on an active basis.

10. The liquid detergent composition of claim 1, wherein the at least one of a salt of an ethoxylated C₁₀-C₁₆ pareth sulfate surfactant is present at 1 to 20% by weight of the composition on an active basis.

11. The liquid detergent composition of claim 1, wherein the at least one amine oxide is present at 1 to 10% by weight of the composition on an active basis.

12. The liquid detergent composition of claim 1, wherein the surfactants consist essentially of a mixture of a sodium C₁₄-C₁₇ paraffin sulfonate, a sodium C₁₂-C₁₃ pareth sulfate(2EO), lauramidopropyldimethylamine oxide, and myristamidopropylamine oxide.

13. The liquid detergent composition of claim 1, wherein the beads are made from a material chosen from alginate, agar, gum arabic, gelatin, and combinations thereof.

14. The liquid detergent composition of claim 1, wherein the composition has a viscosity of less than 5,000 mPas at 25° C.

15. The liquid detergent composition of claim 1, wherein the liquid detergent composition has a viscosity of less than 1,000 mPas at 25° C.

16. The liquid detergent composition of claim 1, wherein at least 90% of the beads remain suspended for at least 2 weeks at room temperature.

17. The liquid detergent composition of claim 1, wherein the surfactants consist essentially of 14-20% by weight of sodium C₁₄-C₁₇ paraffin sulfonate, 3-6% by weight of sodium C₁₂-C₁₃ pareth sulfate(2EO), 1-3% by weight of lauramidopropyldimethylamine oxide, and 0.1-1% by weight myristamidopropylamine oxide, and the suspending agent is present at 0.1-0.2% by weight, all on an actives basis.
